(19) United States
(12) Patent Application Publication
(10) Pub. No.: US 2014/0249067 A1
(43) Pub. Date: Sep. 4, 2014

(54) PREMIX CONTAINING OPTICAL BRIGHTENER

(71) Applicant: The Procter & Gamble Company, Cincinnati, OH (US)

(72) Inventors: Samantha Jo COST, Cincinnati, OH (US); Cesar Edwin DARIO, Liberty Township, OH (US); Joseph James ELSEN, Cincinnati, OH (US); James William HOLDER, Fort Thomas, KY (US); Peter J. MCMAHON, Fairfield Township, OH (US); Jeffrey Gordon THOMAS, Cincinnati, OH (US); Gregory Thomas WANING, Fairfield, OH (US); Shulin Larry ZHANG, West Chester, OH (US); Michael Shawn HOPPINS, Cincinnati, OH (US); Kenneth Michael KEMEN, Cincinnati, OH (US)

(73) Assignee: The Procter & Gamble Company, Cincinnati, OH (US)

(21) Appl. No.: 14/170,661

(22) Filed: Feb. 3, 2014

Related U.S. Application Data
(60) Provisional application No. 61/772,294, filed on Mar. 4, 2013.

(51) Int. Cl. C11D 3/42

(52) U.S. Cl. CPC C11D 3/42
USPC 510/324

(57) ABSTRACT

The present disclosure relates to a storage-stable brightener premix composition, which is substantially free of water and comprises an optical brightener, monoethanolamine, and, optionally, a solvent. The present disclosure also relates to methods of making and using the same.

### FIELD OF THE INVENTION

The present disclosure relates to a storage-stable brightener premix composition, which is substantially free of water and comprises an optical brightener, monoethanolamine, and, optionally, a solvent. The present disclosure also relates to methods of making and using the same.

### BACKGROUND OF THE INVENTION

Optical brighteners are a class of fluorescent materials that absorb light in the ultraviolet regions of the electromagnetic spectrum (e.g., less than 400 nm) and re-emit light in the violet and blue regions of the electromagnetic spectrum (e.g., greater than 400 nm). Optical brighteners are used in a variety of applications to enhance the color or appearance of materials, such as fabrics. Generally, optical brighteners are used to increase the perceived whiteness of such materials by increasing the overall amount of blue light emanating from the material (i.e., reflected from the material and emitted by substances deposited on the material).

Optical brighteners, especially particulate brighteners, are sometimes combined with one or more liquid solvents to form an optical brightener premix, and this optical brightener premix is then added to a liquid composition, e.g., a liquid laundry detergent composition, containing a substantial portion, for example more than 50% by weight, or more than 70% by weight, or more than 90% by weight, of the balance of components of the liquid composition. Forming a brightener premix and adding the premix to the liquid composition, rather than adding particulate brightener directly to the liquid composition, allows for better, more even mixing of the components of the liquid composition.

Brightener premixes containing a mixture of brightener, e.g., brightener 15, monoethanolamine (MEA), and nonionic surfactant, for use in liquid laundry detergent compositions, are known. And, MEA is known to act as a counterion to optical brighteners and thus provide better brightener stability. Brightener premixes containing brightener, e.g., brightener 36, monoethanolamine, and water (4.5% brightener, 60% MEA, 35.5% H₂O) as well as brightener premixes containing anionic brightener, polyhydroxy fatty acid amide, and water, for use in liquid laundry detergent compositions, are also known. Finally, stable stilbene fluorescent brightener solutions that contain a stilbene fluorescent brightener substituted by sulfo groups and a stabilizing fatty amine oxyalkylation product are known.

There still remains a need for stable, higher-active optical brightener premixes that contain increased levels of brightener and decreased levels of water and surfactant. Higher-active premixes provide the formulator flexibility and may be useful in unitized dose compositions. The present disclosure seeks to provide such optical brightener premixes.

### SUMMARY OF THE DISCLOSURE

The present disclosure provides a fluorescent brightener premix composition comprising from about 1% to about 70% by weight of monoethanolamine, from about 1% to about 10% by weight of at least one fluorescent brightener, and, optionally, from about 1% to about 30% by weight of a solvent, e.g., diethylene glycol, where the premix composition is substantially free of water.

The present disclosure also provides a process for the manufacture of a detergent composition comprising a fluorescent brightener comprising the steps of: a) forming a fluorescent brightener premix composition comprising from about 1% to about 70% by weight of monoethanolamine, from about 1% to about 10% by weight of at least one fluorescent brightener, and, optionally, from about 1% to about 30% by weight of a solvent, e.g., diethylene glycol, where the premix composition is substantially free of water; and b) combining the premix composition with the remaining components of the detergent composition, including at least one surfactant.

### DETAILED DESCRIPTION OF THE DISCLOSURE

As used herein, the articles “a” and “an” when used in a claim, are understood to mean one or more of what is claimed or described.

As used herein, the terms “include,” “includes,” and “including” are meant to be non-limiting.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included.

Unless otherwise noted, all component or composition levels are in reference to the active portion of that component or composition, and are exclusive of impurities, for example, residual solvents or by-products, which may be present in commercially available sources of such components or compositions. By weight according to the present disclosure shall means % by weight.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The present disclosure relates to stable, higher-active optical brightener premixes that contain increased levels of brightener and decreased levels of water and surfactant. Higher-active premixes provide the formulator flexibility and may be useful in unitized dose compositions. More specifically, the present disclosure relates to a fluorescent brightener premix composition comprising from about 1% to about 70% by weight of monoethanolamine, from about 1% to about 10% by weight of at least one fluorescent brightener, and, optionally, from about 1% to about 30% by weight of diethylene glycol, where the premix composition is substantially free of water.

### Monoethanolamine

The fluorescent brightener premix compositions of the present invention generally contain from about 1% to about 70%, by weight of the premix composition, of monethanolamine (“MEA”). In some aspects, the fluorescent brightener premix compositions comprise from about 15% to about 70%, by weight of the premix composition, of MEA. In certain aspects, the fluorescent brightener premix compositions comprise from about 20% to about 70%, or from about 25% to about 70%, or from about 30% to about 70%, by weight of the premix composition, of MEA. In other aspects, the fluorescent brightener premix compositions comprise from about 35% to about 70%, or from about 40% to about 70%, or from about 45% to about 70%, by weight of the premix composition, of MEA. In some aspects, the fluorescent brightener premix compositions comprise from about 50% to about 70%, or from about 55% to about 70%, or from about 60% to about 70%, by weight of the premix composition, of MEA.

Other alkanolamines can be used as alternatives to MEA. Suitable alkanolamines include diethanolamine, triethanolamine, and mixtures of thereof with one another and with MEA.

### Optical Brightener

The terms “optical brighteners,” “fluorescent whitening agents,” and “fluorescent brightener” are used interchangeably herein. The fluorescent brightener premix compositions of the present invention generally contain from about 1% to about 10%, by weight of the premix composition, of at least one fluorescent brightener. In some aspects, the fluorescent brightener premix compositions comprise from about 3% to about 10%, by weight of the premix composition, of at least one fluorescent brightener. In certain aspects, the fluorescent brightener premix compositions comprise from about 5% to about 10%, by weight of the premix composition, of at least one fluorescent brightener. In further aspects, the fluorescent brightener premix compositions comprise from about 6% to about 9%, by weight of the premix composition, of at least one fluorescent brightener. In some aspects, the fluorescent brightener premix compositions comprise from about 8% to about 9%, by weight of the premix composition, of at least one fluorescent brightener.

Commercial optical brighteners which may be useful in the present invention can be classified into subgroups, which include, but are not necessarily limited to, derivatives of stilbene, pyrazoline, coumarin, benzoxazoles, carboxylic acid, methinecyanines, dibenzothiophene-5,5-dioxide, azoles, 5- and 6-membered-ring heterocycles, and other miscellaneous agents. Examples of such brighteners are disclosed in “The Production and Application of Fluorescent Brightening Agents”, M. Zahradnik, Published by John Wiley & Sons, New York (1982). Specific nonlimiting examples of optical brighteners which are useful in the present compositions are those identified in U.S. Pat. No. 4,790,856 and U.S. Pat. No. 3,646,015.

Suitable optical brighteners include those having the structural formula:

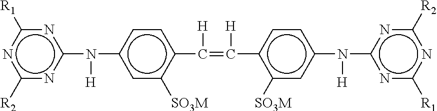

where R₁ is selected from anilino, N-2-bis-hydroxyethyl or NH-2-hydroxyethyl; R₂ is selected from N-2-bis-hydroxyethyl, N-2-hydroxyethyl-N-methylamino, morphilino, chloro, or amino; and M is a salt-forming cation, such as sodium or potassium.

When in the above formula, R₁ is anilino, R₂ is N-2-bis-hydroxyethyl and M is a cation, such as sodium, the brightener is 4,4′,bis[(4-anilino-6-(N-2-bis-hydroxyethyl)-s-triazine-2-yl)amino]-2,2′-stilbenedisulfonic acid and disodium salt. This particular brightener species is commercially marketed under the tradename Tinopal-UNPA-GX by Ciba-Geigy Corporation.

When in the above formula, R₁ is anilino, R₂ is N-2-hydroxyethyl-N-2-methylamino and M is a cation, such as sodium, the brightener is 4,4′-bis[(4-anilino-6-(N-2-hydroxyethyl-N-methylamino)-s-triazine-2-yl)amino]2,2′-stilbenedisulfonic acid disodium salt. This particular brightener species is commercially marketed under the tradename Tinopal 5BM-GX by Ciba-Geigy Corporation.

When in the above formula, R₁ is anilino, R₂ is morphilino, and M is a cation, such as sodium, the brightener is 4,4′-bis[(4-anilino-6-morphilino-s-triazine-2-yl)amino]2,2′-stilbenedisulfonic acid, sodium salt. This particular brightener species is commercially marketed under the tradename Tinopal AMS-GX by Ciba Geigy Corporation.

Another suitable brightener is C.I fluorescent brightener 260 having the following structure:

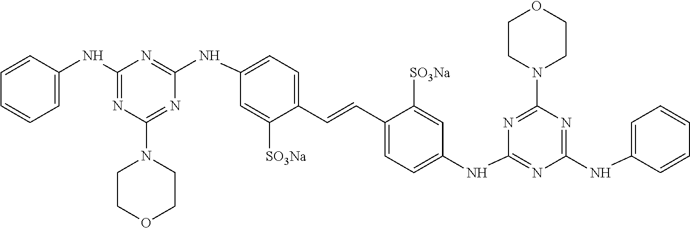

Typically, the C.I. fluorescent brightener 260 is predominantly in beta-crystalline form. Predominantly in beta-crystalline form means at least 50 wt %, or at least 75 wt %, or even at least 90 wt %, or at least 99 wt %, or even substantially all, of the brightener is in beta-crystalline form. In some aspects, however, the brightener is predominantly in alpha-crystalline form, which means that typically at least 50 wt %, at least 75 wt %, at least 90 wt %, at least 99 wt %, or even substantially all, of the C.I. fluorescent brightener 260 is in alpha-crystalline form.

The brightener may be in a micronized particulate form, having a weight average primary particle size of from 3 to 30 micrometers, or from 3 micrometers to 20 micrometers, or from 3 to 10 micrometers.

Another suitable brightener has the structure below:

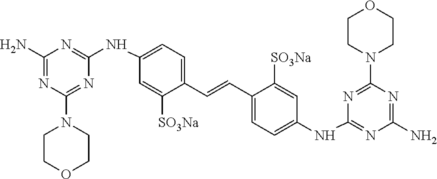

In some aspects, the fluorescent brightener is selected from disodium 4,4′-bis{[4-anilino-6-morpholino-s-triazin-2-yl]amino}-2,2′-stilbenedisulfonate, disodium 4,4′-bis-(2-sulfostryl)biphenyl, or a mixture thereof. In certain aspects, the fluorescent brightener is disodium 4,4′-bis{[4-anilino-6-morpholino-s-triazin-2-yl]amino}-2,2′-stilbenedisulfonate.

### Solvent

The fluorescent brightener premix compositions of the present invention may optionally comprise a solvent. In some aspects, brightener premix compositions comprise from about 1% to about 30%, by weight of the premix composition, of at least one solvent. In some aspects, the fluorescent brightener premix compositions comprise from about 5% to about 30%, or from about 10% to about 30%, or from about 15% to about 30%, or from about 20% to about 30%, or from about 25% to about 30%, by weight of the premix composition, of at least one solvent.

Suitable solvents include short-chain alcohol or short-chain diol. In some aspects, the short-chain alcohol or short-chain diol have four carbons or fewer. In some aspects, the solvent is selected from propanediol, diethylene glycol, ethanol, sodium cumene sulfonate (SCS), sodium toluene sulfonate (NaTS), sodium xylene sulfonate (SXS), or mixtures thereof. In some aspects, the solvent is selected from diethylene glycol, ethanol, sodium cumene sulfonate (SCS), or mixtures thereof. In certain aspects, the solvent is diethylene glycol.

The fluorescent brightener premix compositions of the present disclosure generally have a pH in the range of from about 10 to about 14, or from about 11 to about 14, or from about 12 to about 14, or from about 13 to about 14.

### Viscosity

Unless specifically indicated to the contrary, all stated viscosities are those measured at a shear rate of 60 RPM and at a temperature of 21.1° C. Viscosity herein can be measured with any suitable viscosity-measuring instrument, e.g., a Brookfield DV-II+ Rheometer at a shear rate of 60 RPM and Spindle 31.

The viscosities of the fluorescent brightener premix compositions of the present disclosure are generally from about 50 centipoise to about 150 centipoise at 21.1° C.

### Process for the Production of the Optical Brightener Premix

The optical brightener premix of the present disclosure is produced by adding MEA and solvent, e.g., diethylene glycol, into a suitable mixing vessel (for example, a vessel with a Z/T of about 1.0, containing agitators with a D/T of about 0.3) and mixing the two materials until a clear, homogenous solution of low viscosity (e.g., less than about 100 cPs) is formed. The optical brightener (in the form of a powder) is then added directly to the mixture of MEA and solvent and the mixture of optical brightener, MEA, and solvent is mixed (generally for about 30 minutes to about 60 minutes), until a clear, isotropic solution of low viscosity (e.g., less than about 100 cPs) is achieved. Care is taken in delivering the optical brightener powder to the vessel, in order to avoid powder buildup on the walls of the vessel or the surface of the fluid.

During each of the mixing steps, adequate energy of mixing is applied, for example, enough mixing energy to create a slight vortex in the sample and ensure that the powder is dispersed across the surface of the fluid and pulled down into the fluid. Typically, if the energy of mixing is not sufficient to create a vortex, then the energy of mixing is not sufficient to disperse/dissolve the powder at the rate at which it is delivered. There is also an optimal delivery rate for delivering the optical brightener powder. Generally, powder delivery rates of between about 3% and about 8% of the total powder weight amount per minute allow for adequate dispersion/dissolution of the powder. If the powder delivery rate is too high, the powder tends to clump and excess powder collects on the fluid surface, leading to long mix/dissolution times. If the powder delivery rate is too low, good dispersion and dissolution may still be achieved, but the batch time is not efficient.

Once all the powder has been delivered to the batch, the entire mixture is mixed for an additional about 10 to about 30 minutes to allow for complete dissolution/dispersion of the powder. The final mixture is typically a yellow to light yellow solution that is clear, isotropic, and substantially free of any floating particles.

### Detergent Composition

A further aspect of the present disclosure relates to a detergent composition comprising the fluorescent brightener premix described above. The detergent compositions herein may be in the form of paste, gel, pourable gels, non-pourable gels, liquids, including heavy-duty liquids, or a unitized dose form. In some aspects, the detergent composition is in liquid form. The detergent composition generally comprises from about 0.1% to about 10%, by weight of the detergent composition, of the brightener premix composition. In some aspects, the detergent composition comprises from about 0.5% to about 9%, by weight of the detergent composition, of the brightener premix composition. In certain aspects, the detergent composition comprises from about 1% to about 8%, or from about 1.4% to about 7%, or from about 2% to about 6%, by weight of the detergent composition, of the brightener premix composition. In other aspects, the detergent composition comprises from about 2.5% to about 5%, or from about 3% to about 4.5%, or from about 3.5% to about 4.2%, by weight of the detergent composition, of the brightener premix composition. In some aspects, the detergent composition comprises from about 1.4% to about 4.2%, by weight of the detergent composition, of the brightener premix composition.

The fluorescent brightener premix may be combined with the remaining detergent composition ingredients at any point in the manufacture of the detergent composition. Generally, the brightener premix is added at an appropriate point so as not to greatly affect the viscosity of the detergent composition.

### Detergent Ingredients

In some aspects, the detergent composition may comprise any of the following ingredients. The ingredients listed below are intended to be non-limiting.

### Surfactants

The detergent compositions of the present disclosure may comprise a detersive surfactant or a detersive surfactant system. The detersive surfactant may be selected from nonionic surfactants, anionic surfactants, cationic surfactants, ampholytic surfactants, zwitterionic surfactants, semi-polar nonionic surfactants or mixtures thereof. When present, surfactant is typically present at a level of from about 0.1% to about 60%, from about 1% to about 50% or even from about 5% to about 40% by weight of the detergent composition.

Suitable anionic detersive surfactants include sulphate and sulphonate detersive surfactants.

Suitable sulphonate detersive surfactants include alkyl benzene sulphonate, in one aspect, C₁₀₋₁₃ alkyl benzene sulphonate. Suitable alkyl benzene sulphonate (LAS) may be obtained, by sulphonating commercially available linear alkyl benzene (LAB); suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic detersive surfactant is alkyl benzene sulphonate that is obtained by DETAL catalyzed process, although other synthesis routes, such as HF, may also be suitable. In one aspect a magnesium salt of LAS is used.

Suitable sulphate detersive surfactants include alkyl sulphate, in one aspect, C₈₋₁₈ alkyl sulphate, or predominantly C₁₂ alkyl sulphate.

Another suitable sulphate detersive surfactant is alkyl alkoxylated sulphate, in one aspect, alkyl ethoxylated sulphate, in one aspect, a C₈₋₁₈ alkyl alkoxylated sulphate, in another aspect, a C₈₋₁₈ alkyl ethoxylated sulphate, typically the alkyl alkoxylated sulphate has an average degree of alkoxylation of from 0.5 to 20, or from 0.5 to 10, typically the alkyl alkoxylated sulphate is a C₈₋₁₈ alkyl ethoxylated sulphate having an average degree of ethoxylation of from 0.5 to 10, from 0.5 to 7, from 0.5 to 5 or even from 0.5 to 3.

The alkyl sulphate, alkyl alkoxylated sulphate and alkyl benzene sulphonates may be linear or branched, substituted or un-substituted.

The detersive surfactant may be a mid-chain branched detersive surfactant, in one aspect, a mid-chain branched anionic detersive surfactant, in one aspect, a mid-chain branched alkyl sulphate and/or a mid-chain branched alkyl benzene sulphonate, for example a mid-chain branched alkyl sulphate. In one aspect, the mid-chain branches are C₁₋₄ alkyl groups, typically methyl and/or ethyl groups.

Suitable non-ionic detersive surfactants are selected from the group consisting of: C₈-C₁₈ alkyl ethoxylates, such as, NEODOL® non-ionic surfactants from Shell; C₆-C₁₂ alkyl phenol alkoxylates wherein the alkoxylate units may be ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols; C₁₄-C₂₂ mid-chain branched alkyl alkoxylates, typically having an average degree of alkoxylation of from 1 to 30; alkylpolysaccharides, in one aspect, alkylpolyglycosides; polyhydroxy fatty acid amides; ether capped poly(oxyalkylated) alcohol surfactants; and mixtures thereof.

Suitable non-ionic detersive surfactants include alkyl polyglucoside and/or an alkyl alkoxylated alcohol.

In one aspect, non-ionic detersive surfactants include alkyl alkoxylated alcohols, in one aspect C₈₋₁₈ alkyl alkoxylated alcohol, for example a C₈₋₁₈ alkyl ethoxylated alcohol, the alkyl alkoxylated alcohol may have an average degree of alkoxylation of from 1 to 50, from 1 to 30, from 1 to 20, or from 1 to 10. In one aspect, the alkyl alkoxylated alcohol may be a C₈₋₁₈ alkyl ethoxylated alcohol having an average degree of ethoxylation of from 1 to 10, from 1 to 7, more from 1 to 5 or from 3 to 7. The alkyl alkoxylated alcohol can be linear or branched, and substituted or un-substituted.

Suitable nonionic surfactants include those sold under the tradename Lutensol® from BASF.

Suitable cationic detersive surfactants include alkyl pyridinium compounds, alkyl quaternary ammonium compounds, alkyl quaternary phosphonium compounds, alkyl ternary sulphonium compounds, and mixtures thereof.

Suitable cationic detersive surfactants are quaternary ammonium compounds having the general formula:

(R)(R₁)(R₂)(R₃)N⁺X⁻

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, suitable anions include: halides, for example chloride; sulphate; and sulphonate. Suitable cationic detersive surfactants are mono-C₆₋₁₈ alkyl mono-hydroxyethyl di-methyl quaternary ammonium chlorides. Highly suitable cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

Suitable amphoteric/zwitterionic surfactants include amine oxides and betaines.

Anionic surfactants of the present invention and adjunct anionic cosurfactants, may exist in an acid form, and the acid form may be neutralized to form a surfactant salt which is desirable for use in the present detergent compositions. Typical agents for neutralization include the metal counterion base such as hydroxides, eg, NaOH or KOH. Further preferred agents for neutralizing anionic surfactants of the present invention and adjunct anionic surfactants or cosurfactants in their acid forms include ammonia, amines, or alkanolamines. Alkanolamines are preferred. Suitable non-limiting examples including monoethanolamine, diethanolamine, triethanolamine, and other linear or branched alkanolamines known in the art; for example, highly preferred alkanolamines include 2-amino-1-propanol, 1-aminopropanol, monoisopropanolamine, or 1-amino-3-propanol. Amine neutralization may be done to a full or partial extent, e.g. part of the anionic surfactant mix may be neutralized with sodium or potassium and part of the anionic surfactant mix may be neutralized with amines or alkanolamines.

Fabric Care Benefit Agents

The detergent compositions may comprise a fabric care benefit agent. As used herein, “fabric care benefit agent” refers to any material that can provide fabric care benefits such as fabric softening, color protection, pill/fuzz reduction, anti-abrasion, anti-wrinkle, and the like to garments and fabrics, particularly on cotton and cotton-rich garments and fabrics, when an adequate amount of the material is present on the garment/fabric. Non-limiting examples of fabric care benefit agents include cationic surfactants, silicones, polyolefin waxes, latexes, oily sugar derivatives, cationic polysaccharides, polyurethanes, fatty acids and mixtures thereof. Fabric care benefit agents when present in the composition, are suitably at levels of up to about 30% by weight of the composition, more typically from about 1% to about 20%, preferably from about 2% to about 10%.

Detersive Enzymes

The detergent composition may comprise an enzyme. Suitable detersive enzymes for use herein include protease, amylase, lipase, cellulase, carbohydrase including mannanase and endoglucanase, and mixtures thereof. Enzymes can be used at their art-taught levels, for example at levels recommended by suppliers such as Novo and Genencor. Typical levels in the compositions are from about 0.0001% to about 5%. When enzymes are present, they can be used at very low levels, e.g., from about 0.001% or lower, in certain embodiments of the disclosure; or they can be used in heavier-duty laundry detergent formulations in accordance with the disclosure at higher levels, e.g., about 0.1% and higher. In accordance with a preference of some consumers for “non-biological” detergents, the present disclosure includes both enzyme-containing and enzyme-free embodiments.

Deposition Aid

As used herein, “deposition aid” refers to any cationic polymer or combination of cationic polymers that significantly enhance the deposition of a fabric care benefit agent onto the fabric during laundering. Typically, the deposition aid is a cationic or amphoteric polymer. The amphoteric polymers of the present disclosure will also have a net cationic charge, i.e.; the total cationic charges on these polymers will exceed the total anionic charge. Nonlimiting examples of deposition enhancing agents are cationic polysaccharides, chitosan and its derivatives and cationic synthetic polymers. Preferred cationic polysaccharides include cationic cellulose derivatives, cationic guar gum derivatives, chitosan and derivatives and cationic starches.

Rheology Modifier

In some aspects, the detergent composition comprises a rheology modifier. In some aspects, the rheology modifier is selected from the group consisting of non-polymeric crystalline, hydroxy-functional materials, polymeric rheology modifiers which impart shear thinning characteristics to the aqueous liquid matrix of the composition. Crystalline, hydroxy-functional materials are rheology modifiers which form thread-like structuring systems throughout the matrix of the composition upon in situ crystallization in the matrix. Specific examples of preferred crystalline, hydroxyl-containing rheology modifiers include castor oil and its derivatives. Especially preferred are hydrogenated castor oil derivatives such as hydrogenated castor oil and hydrogenated castor wax. Commercially available, castor oil-based, crystalline, hydroxyl-containing rheology modifiers include THIXCIN® from Rheox, Inc. (now Elementis).

In some aspect, the rheology modifier is a polymeric rheology modifier. In some aspects, the rheology modifier is selected from polyacrylates, polymeric gums, other non-gum polysaccharides, and combinations of these polymeric materials. Preferred polymeric gum materials include pectine, alginate, arabinogalactan (gum Arabic), carrageenan, gellan gum, xanthan gum, guar gum and mixtures thereof.

Builder

The detergent compositions of the present disclosure may optionally comprise a builder. When a builder is used, the subject detergent composition typically comprises at least about 1%, from about 2% to about 60% or even from about 5% to about 10% builder, by weight of the detergent composition. The composition may even be substantially free of builder. Typical zeolite builders include zeolite A, zeolite P and zeolite MAP. A typical phosphate builder is sodium tri-polyphosphate.

Bleaching System

Bleaching agents suitable herein include chlorine and oxygen bleaches, especially inorganic perhydrate salts such as sodium perborate mono- and tetrahydrates and sodium percarbonate optionally coated to provide controlled rate of release (see, for example, GB-A-1466799 on sulfate/carbonate coatings), preformed organic peroxyacids and mixtures thereof with organic peroxyacid bleach precursors and/or transition metal-containing bleach catalysts (especially manganese or cobalt). Inorganic perhydrate salts are typically incorporated at levels in the range from about 1% to about 40% by weight, preferably from about 2% to about 30% by weight and more preferably from abut 5% to about 25% by weight of composition. Peroxyacid bleach precursors preferred for use herein include precursors of perbenzoic acid and substituted perbenzoic acid; cationic peroxyacid precursors; peracetic acid precursors such as TAED, sodium acetoxybenzene sulfonate and pentaacetylglucose; pernonanoic acid precursors such as sodium 3,5,5-trimethylhexanoyloxybenzene sulfonate (iso-NOBS) and sodium nonanoyloxybenzene sulfonate (NOBS); amide substituted alkyl peroxyacid precursors (EP-A-0170386); and benzoxazin peroxyacid precursors (EP-A-0332294 and EP-A-0482807).

Bleach precursors are typically incorporated at levels in the range from about 0.5% to about 25%, preferably from about 1% to about 10% by weight of composition while the preformed organic peroxyacids themselves are typically incorporated at levels in the range from 0.5% to 25% by weight, more preferably from 1% to 10% by weight of composition.

Bleach catalysts preferred for use herein include the manganese triazacyclononane and related complexes (U.S. Pat. No. 4,246,612, U.S. Pat. No. 5,227,084); Co, Cu, Mn and Fe bispyridylamine and related complexes (U.S. Pat. No. 5,114,611); and pentamine acetate cobalt(III) and related complexes (U.S. Pat. No. 4,810,410).

Perfume

Perfumes are preferably incorporated into the detergent compositions of the present disclosure. The perfumes may be prepared as a premix liquid, may be linked with a carrier material, such as cyclodextrin or may be encapsulated.

Organic solvent

In some aspects, the detergent compositions comprise organic solvent (in addition to any solvent present in the optical brightener premix). In some aspects, the detergent compositions comprise from about 0.05% to about 25%, or from about 0.1% to about 15%, or from about 1% to about 10% by weight of the composition organic solvent. In some aspects, the compositions are substantially free of organic solvent.

In some aspects, the organic solvent may be a short-chain alcohol or a short-chain diol. In some aspects, the short-chain alcohol or short-chain diol have four carbons or fewer. In some aspects, the organic solvent is selected from propanediol, DEG, ethanol, SCS, NaTS, SXS, and mixtures thereof. In some aspects, the organic solvent is propanediol. In some aspects, the organic solvent is selected from 1,2-propanediol, methanol, ethanol, glycerol, dipropylene glycol, methyl propanediol, and mixtures thereof. Other lower alcohols, such C1-C4 alkanolamines, for example monoethanolamine and/or triethanolamine, can also be used.

Hydrotropes

In some aspects, the detergent compositions comprise a hydrotrope. In some aspects, the detergent compositions comprise from about 0.01% to about 10%, by weight of the composition of a hydrotrope. In some aspects, the hydrotrope is a short-chain hydrotrope having four or fewer carbons in a carbon backbone. In some aspects, the hydrotrope is selected from toluenesulfonates, cumenesulfonate, naphthalenesulfontes, or mixtures thereof. In some aspects, the hydrotrope is a substituted phenyl sulfonate.

Pearlescent Agent

The detergent compositions of the present disclosure may comprise a pearlescent agent. Said pearlescent agent may be organic or inorganic, but is preferably inorganic. Most preferably the pearlescent agent is selected from mica, TiO2 coated mica, bismuth oxychloride, or mixtures thereof.

Other Adjuncts

Examples of other suitable cleaning adjunct materials include, but are not limited to, alkoxylated benzoic acids or salts thereof such as trimethoxy benzoic acid or a salt thereof (TMBA); enzyme stabilizing systems; scavenging agents including fixing agents for anionic dyes, complexing agents for anionic surfactants, and mixtures thereof; optical brighteners or fluorescers; soil release polymers; soil suspending polymers; dispersants; suds suppressors; dyes; colorants; color speckles; colored beads, spheres or extrudates; preservatives; suds supressors; clay softening agents and mixtures thereof.

Unit Dose Form

In some aspects, the detergent composition is in the form of a unit dose article. In some aspects, the unit dose article comprises the detergent composition encapsulated in a water-soluble film or pouch. In some aspects, the water-soluble film or pouch comprises polyvinyl alcohol, polyvinyl acetate, or mixtures thereof. In some aspects, the unit dose article comprises at least two compartments or at least three compartments. In some aspects, at least one compartment may be superimposed on another compartment.

### EXAMPLES

The present examples are representative of the present disclosure and not intended to be limiting.

TABLE 1
Brightener Premix.

| | Brightener | Brightener | Brightener | Brightener | Brightener | Brightener | | |
|---|---|---|---|---|---|---|---|---|
| | Premix A | Premix B | Premix C | Premix D | Premix E | Premix F | Comparative | Comparative |
| | (wt %) | (wt %) | (wt %) | (wt %) | (wt %) | (wt %) | example | example |
| Nonionic 24-9 | 0 | 0 | 0 | 0 | 0 | 0 | 20.00 | 10.00 |
| Monoethanol- | 90.83 | 84.67 | 62.32 | 75.73 | 80.2 | 66.79 | 71.28 | 80.21 |
| amine (MEA) | | | | | | | | |
| Diethylene | 0 | 5.0 | 30 | 15 | 10 | 25 | 0 | 0 |
| glycol (DEG) | | | | | | | | |
| Fluorescent | 9.17 | 10.33 | 7.68 | 9.27 | 9.8 | 8.21 | 8.72 | 9.79 |
| Whitening | | | | | | | | |
| Agent¹ | | | | | | | | |
| Stability at 4 | Stable² | Stable² | Stable² | Stable² | Stable² | Stable² | Unstable³ | Unstable³ |
| weeks at 40° C. | | | | | | | | |

¹disodium 4,4′-bis{[4-anilino-6-morpholino-s-triazin-2-yl]amino}-2,2′-stilbenedisulfonate.
²“Stable” indicates that there was no phase splitting in the premix composition sample and the sample was consistent with a clear to slightly yellow isotropic solution that is substantially free of any visible materials.
³“Unstable” indicates that the premix composition sample exhibited a thick, gel-like consistency.

Stability Assessment

The stabilities of brightener premix compositions A-F from Table 1 were assessed. The overall stability assessment is based on several stressed conditions to ensure that the premix is stable in normal and expected environmental conditions. The stability assessment consists of testing at different temperature/humidity conditions based on International Conference on Harmonization, (ICH) guidelines using visual assessment of any changes through 12 weeks of study. The optimal premix was stable across a range of temperatures studied, from 5° C. to 40° C. In addition to the temperature study, the samples were tested in a series of freeze/thaw cycles to understand any physical changes. This testing was conducted by placing samples in an ambient temperature condition and then alternating between freezing and thawing conditions for a total of 3 cycles. The optimal premix was stable across all three freeze/thaw cycles.

TABLE 3
Liquid Detergent.

| | Liquid | Liquid | Liquid |
|---|---|---|---|
| | Detergent | Detergent | Detergent |
| | A (wt %) | B (wt %) | C (wt %) |
| AES C₁₂₋₁₅ alkyl ethoxy (1.8) sulfate | 10.9 | 10.9 | 10.9 |
| Alkyl benzene sulfonate ² | 1.56 | 1.56 | 1.56 |
| Sodium formate | 2.66 | 2.66 | 2.66 |
| Sodium hydroxide | 0.21 | 0.21 | 0.21 |
| Monoethanolamine (MEA) | 1.65 | 1.65 | 1.65 |
| Diethylene glycol (DEG) | 4.10 | 4.10 | 4.10 |
| AE9³ | 0.40 | 0.40 | 0.40 |
| C16AE7 | 3.15 | 3.15 | 3.15 |
| Chelant⁴ | 0.18 | 0.18 | 0.18 |
| Citric Acid | 1.70 | 1.70 | 1.70 |
| C₁₂₋₁₈ Fatty Acid | 1.47 | 1.47 | 1.47 |
| Borax | 1.19 | 1.19 | 1.19 |
| Ethanol | 1.44 | 1.44 | 1.44 |
| Ethoxylated Polyethyleneimine ¹ | 1.35 | 1.35 | 1.35 |
| A compound having the following general structure: | 0.40 | 0.40 | 0.40 |
| bis((C₂H₅O)(C₂H₄O)n)(CH₃)—N⁺—CₓH₂ₓ—N⁺—(CH₃)-bis((C₂H₅O)(C₂H₄O)n), | | | |
| wherein n = from 20 to 30, and x = from 3 to 8, | | | |
| or sulphated or sulphonated variants thereof | | | |
| 1,2-Propanediol | 2.40 | 2.40 | 2.40 |
| Protease (54.5 mg active/g)⁶ | 0.89 | 0.89 | 0.89 |
| Mannanase: Mannaway ® (25.6 mg active/g)⁵ | 0.04 | 0.04 | 0.04 |
| Amylase: Natalase ® (29 mg active/g)⁵ | 0.14 | 0.14 | 0.14 |
| Brightener Premix⁷ | 1.4 | 0 | 1.2 |
| Brightener Premix⁸ | 0 | 1.2 | 0 |

| | |
|---|---|
| Water, perfume, dyes & other components | Balance |

¹ Polyethyleneimine (MW = 600) with 20 ethoxylate groups per —NH.
² Linear alkylbenzenesulfonate having an average aliphatic carbon chain length C₁₁-C₁₂ supplied by Stepan, Northfield, Illinois, USA
³AE9 is C₁₂₋₁₃ alcohol ethoxylate, with an average degree of ethoxylation of 9, supplied by Huntsman, Salt Lake City, Utah, USA
⁴Suitable chelants are, for example, diethylenetetraamine pentaacetic acid (DTPA) supplied by Dow Chemical, Midland, Michigan, USA or Hydroxyethane di phosphonate (HEDP) supplied by Solutia, St Louis, Missouri, USA Bagsvaerd, Denmark
⁵Natalase ®, Mannaway ® are all products of Novozymes, Bagsvaerd, Denmark.
⁶Proteases may be supplied by Genencor International, Palo Alto, California, USA (e.g. Purafect Prime ®) or by Novozymes, Bagsvaerd, Denmark (e.g. Liquanase ®, Coronase ®).
⁷Brightener premix F from Table 1.
⁸Brightener premix C from Table 1.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any disclosure disclosed or claimed herein or that it alone, or in any combination with any other reference or references, teaches, suggests or discloses any such disclosure. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. A fluorescent brightener premix composition comprising:
a) from about 1% to about 70% by weight of monoethanolamine; and
c) from about 1% to about 10% by weight of at least one fluorescent brightener;
wherein said premix composition is substantially free of water.

2. The fluorescent brightener premix composition according to claim 1, wherein said composition further comprises from about 1% to about 30% by weight of a solvent selected from diethylene glycol, ethanol, sodium cumene sulfonate (SCS), or mixtures thereof.

3. The fluorescent brightener premix composition according to claim 1, wherein said composition is substantially free of surfactant.

4. The fluorescent brightener premix composition according to claim 1, wherein said at least one fluorescent brightener is selected from disodium 4,4′-bis{[4-anilino-6-morpholino-s-triazin-2-yl]amino}-2,2′-stilbenedisulfonate, disodium 4,4′-bis-(2-sulfostryl)biphenyl, or a mixture thereof.

5. The fluorescent brightener premix composition according to claim 1, wherein said at least one fluorescent brightener is disodium 4,4′-bis{[4-anilino-6-morpholino-s-triazin-2-yl]amino}-2,2′-stilbenedisulfonate.

6. The fluorescent brightener premix composition according to claim 2, wherein said fluorescent brightener premix composition comprises from about 15% to about 70% by weight of monoethanolamine; from about 5% to about 30% by weight of a solvent selected from diethylene glycol, ethanol, sodium cumene sulfonate (SCS), or mixtures thereof; and from 3% to about 10% by weight of at least one fluorescent brightener.

7. The fluorescent brightener premix composition according to claim 2, wherein said fluorescent brightener premix composition comprises from about 60% to about 70% by weight of monoethanolamine; from about 15% to about 30% by weight of a solvent selected from diethylene glycol, ethanol, sodium cumene sulfonate (SCS), or mixtures thereof; and from 5% to about 10% by weight of at least one fluorescent brightener.

8. The fluorescent brightener premix composition according to claim 1, wherein the pH of the composition is from about 10 to about 14.

9. The fluorescent brightener premix composition according to claim 1, wherein the fluorescent brightener premix composition has a viscosity of from about 50 centipoise to about 150 centipoise at 21.1° C.

10. The fluorescent brightener premix composition according to claim 3, wherein the fluorescent brightener premix composition is substantially free of nonionic surfactant.

11. A process for the manufacture of a detergent composition comprising a fluorescent brightener comprising the steps of:
a) forming a fluorescent brightener premix composition comprising from about 1% to about 70% by weight of monoethanolamine and from about 1% to about 10% by weight of at least one fluorescent brightener, wherein said premix composition is substantially free of water; and
b) combining said premix composition with the remaining components of the detergent composition, including at least one surfactant.

12. The process according to claim 11, wherein said fluorescent brightener premix composition further comprises from about 1% to about 30% by weight of a solvent selected from diethylene glycol, ethanol, sodium cumene sulfonate (SCS), or mixtures thereof.

13. The process according to claim 11, wherein said at least one fluorescent brightener is selected from disodium 4,4′-bis{[4-anilino-6-morpholino-s-triazin-2-yl]amino}-2,2′-stilbenedisulfonate, disodium 4,4′-bis-(2-sulfostryl)biphenyl, or a mixture thereof.

14. The process according to claim 11, wherein said at least one fluorescent brightener is disodium 4,4′-bis{[4-anilino-6-morpholino-s-triazin-2-yl]amino}-2,2′-stilbenedisulfonate.

15. The process according to claim 12, wherein said fluorescent brightener premix composition comprises from about 15% to about 70% by weight of monoethanolamine; from about 5% to about 30% by weight of a solvent selected from diethylene glycol, ethanol, sodium cumene sulfonate (SCS), or mixtures thereof; and from 3% to about 10% by weight of at least one fluorescent brightener.
